(19) United States
(12) Patent Application Publication
(10) Pub. No.: US 2026/0220876 A1
(43) Pub. Date: Jul. 30, 2026

(54) SPARSE VIEW THREE-DIMENSIONAL (3D) IMAGE RECONSTRUCTION

(71) Applicant: QUALCOMM Incorporated, San Diego, CA (US)

(72) Inventors: Meng-Lin WU, San Diego, CA (US); Yinhao ZHU, La Jolla, CA (US); Sandesh GHIMIRE, San Diego, CA (US); Hong CAI, San Diego, CA (US)

(21) Appl. No.: 19/040,764

(22) Filed: Jan. 29, 2025

(51) Int. Cl. G06T 15/20; G06T 7/70; H04N 13/111; H04N 23/698

(52) U.S. Cl. CPC G06T 15/205; G06T 7/70; H04N 13/111; H04N 23/698; G06T 2207/30241; G06T 2207/30244

(57) ABSTRACT

Systems and techniques are provided for processing one or more images. For example, a process can include obtaining a first image of a scene from a camera and obtaining a second image of the scene from the camera. The first image of the scene is associated with a first pose of the camera and the second image of the scene is associated with a second pose of the camera, different from the first pose. The process can include generating, based on the first image of the scene and the second image of the scene, a three-dimensional (3D) representation of the scene. The process can include generating, based on the 3D representation of the scene, a two-dimensional (2D) image of the 3D representation of the scene associated with a third pose, the third pose being different from the second pose of the camera and the first pose of the camera.

### FIELD

The present disclosure generally relates to image reconstruction. For example, aspects of the present disclosure are related to systems and techniques for reconstructing three-dimensional (3D) environments from still images.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

Many cameras are capable of generating panoramic images. For example, many cameras in handheld devices such as mobile phones and tablets are capable of generating panoramic images. Generation of such panoramic images typically requires a user to rotate the camera while multiple images of the scene are captured. When the image captures are completed, the captured images may be combined into a single panoramic image having a field of view (FoV) greater than the FoV of a single image captured. Such panoramic images may have varying fields of view based on the captured images to be combined.

### BRIEF SUMMARY

Disclosed are systems, apparatuses, methods, and computer-readable media for processing one or more images. According to at least one example, a method is provided for processing one or more images. The method includes: obtaining a first image of a scene from a camera, wherein the first image of the scene is associated with a first pose of the camera; obtaining a second image of the scene from the camera, wherein the second image of the scene is associated with a second pose of the camera, the second pose being different from the first pose; generating, based on the first image of the scene and the second image of the scene, a 3D representation of the scene; and generating, based on the 3D representation of the scene, a 2D image of the 3D representation of the scene associated with a third pose, the third pose being different from the second pose of the camera and the first pose of the camera.

In another example, an apparatus for processing one or more images is provided that includes a memory configured to store at least one frame and one or more processors (e.g., implemented in circuitry) coupled to the memory. The one or more processors are configured to and can: obtain a first image of a scene from a camera, wherein the first image of the scene is associated with a first pose of the camera; obtain a second image of the scene from the camera, wherein the second image of the scene is associated with a second pose of the camera, the second pose being different from the first pose; generate, based on the first image of the scene and the second image of the scene, a 3D representation of the scene; and generate, based on the 3D representation of the scene, a 2D image of the 3D representation of the scene associated with a third pose, the third pose being different from the second pose of the camera and the first pose of the camera.

In another example, a non-transitory computer-readable medium is provided that has stored thereon instructions that, when executed by one or more processors, cause the one or more processors to: obtain a first image of a scene from a camera, wherein the first image of the scene is associated with a first pose of the camera; obtain a second image of the scene from the camera, wherein the second image of the scene is associated with a second pose of the camera, the second pose being different from the first pose; generate, based on the first image of the scene and the second image of the scene, a 3D representation of the scene; and generate, based on the 3D representation of the scene, a 2D image of the 3D representation of the scene associated with a third pose, the third pose being different from the second pose of the camera and the first pose of the camera.

In accordance with another embodiment of the present disclosure, an apparatus for processing one or more images is provided. The apparatus includes: means for obtaining a first image of a scene from a camera, wherein the first image of the scene is associated with a first pose of the camera; means for obtaining a second image of the scene from the camera, wherein the second image of the scene is associated with a second pose of the camera, the second pose being different from the first pose; means for generating, based on the first image of the scene and the second image of the scene, a 3D representation of the scene; and means for generating, based on the 3D representation of the scene, a 2D image of the 3D representation of the scene associated with a third pose, the third pose being different from the second pose of the camera and the first pose of the camera.

In some aspects, one or more of the apparatuses described above is, is part of, or includes a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus includes a display for displaying one or more images, notifications, and/or other displayable data. In some aspects, the apparatus can include one or more sensors. In some cases, the one or more sensors can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an architecture of an image capture and

processing device, in accordance with some examples of the present disclosure;

FIG. 2A is a diagram illustrating a process for capturing panoramic images, in accordance with some examples of the present disclosure;

FIG. 2B is a diagram illustrating a process for generating three-dimensional (3D) photographs, in accordance with some examples of the present disclosure;

FIG. 3 is a block diagram illustrating an example 3D image reconstruction and rendering system, in accordance with some examples of the present disclosure;

FIG. 4 is a block diagram illustrating an example 3D reconstruction engine, in accordance with some examples of the present disclosure;

FIG. 5A is a flow diagram illustrating an example pose analysis process, in accordance with some examples of the present disclosure;

FIG. 5B is a diagram illustrating example poses for a linear trajectory, in accordance with some examples of the present disclosure;

FIG. 5C is a diagram illustrating example poses for an orbital acquisition or a panoramic acquisition, in accordance with some examples of the present disclosure;

FIG. 6A is a diagram illustrating example camera rays for a linear trajectory, in accordance with some examples of the present disclosure;

FIG. 6B is a diagram illustrating example rendering poses for the linear trajectory of FIG. 6A, in accordance with some examples of the present disclosure;

FIG. 6C is a diagram illustrating an example panoramic image for the linear trajectory of FIG. 6A and FIG. 6B, in accordance with some examples of the present disclosure;

FIG. 7A is a diagram illustrating example camera rays for an orbital acquisition, in accordance with some examples of the present disclosure;

FIG. 7B is a diagram illustrating example rendering poses for the orbital acquisition of FIG. 7A, in accordance with some examples of the present disclosure;

FIG. 7C is a diagram illustrating example rendered images from different rendering poses for the orbital acquisition of FIG. 7A and FIG. 7B, in accordance with some examples of the present disclosure;

FIG. 8A is a diagram illustrating example camera rays for a panoramic acquisition, in accordance with some examples of the present disclosure;

FIG. 8B is a diagram illustrating example rendering poses for the panoramic acquisition of FIG. 8A, in accordance with some examples of the present disclosure;

FIG. 8C is a diagram illustrating an example panoramic image for the panoramic acquisition of FIG. 8A and FIG. 8B, in accordance with some examples of the present disclosure;

FIG. 9 is a flow diagram illustrating a process for processing one or more images, in accordance with some examples of the present disclosure;

FIG. 10 is a block diagram illustrating an example of a deep learning network, in accordance with some examples;

FIG. 11 is a block diagram illustrating an example of a convolutional neural network, in accordance with some examples;

FIG. 12 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

Many cameras are capable of generating panoramic images. For example, many cameras in handheld devices such as mobile phones and tablets are capable of generating panoramic images. Generation of such panoramic images typically requires a user to rotate the camera while multiple images of the scene are captured. When the image captures are completed, the captured images may be combined into a single panoramic image having a field of view (FoV) greater than the FoV of a single image captured. Such panoramic images may have varying fields of view based on the captured images to be combined.

However, panoramic image capture often does not support camera translation during capture. For example, images that can be stitched together to form a panoramic image may be restricted to images captured from a common viewpoint (e.g., a common center of projection). In some cases, any deviation from the common viewpoint in the captured images can result in image artifacts. In one illustrative example, an object may be present in a portion of a field of view during a panoramic image capture. In some cases, such an obstruction can interfere with the acquisition of a panoramic image capture.

In some cases, two-dimensional (2D) images with depth information can be utilized to generate a three-dimensional (3D) reconstruction of an environment. For example, 2D images captured from different viewpoints can be utilized to generate a 3D map of a real world environment. In some cases, a virtual camera can be utilized to render 2D images (e.g., using 3D reprojection) from different viewpoints within the 3D map of the environment. In some cases, having freedom to render 2D images of the 3D map from different viewpoints can create an impression of movement within the environment represented in the 3D map. In addition, the quality of the 3D reconstruction may depend on the particular viewpoints used during 2D image acquisition.

However, in some cases, generating a 3D reconstruction of an environment may require a large number of images (e.g. on the order of 100 images) captured from many different viewpoints. In some cases, a 3D reconstruction with a limited set of rendering viewpoints (e.g., for rendering 2D images of the 3D reconstruction) may be adequate for a particular application.

In some implementations, a single 2D image with depth information can be utilized to generate a 3D representation of a portion of an environment. In some cases, 3D reprojection can be used to generate 2D images from viewpoints other than the viewpoint of the image capture.

However, in some cases, artifacts may appear when the amount of view panning exceeds approximately +10 degrees. For example, for any portion of objects not captured in the original image, inpainting of disoccluded missing regions may not have an authentic appearance.

Systems and techniques are needed for increased flexibility in image acquisition panoramic image capture and/or 3D reconstruction based on still images. For example, a panoramic image capture that allows for lateral movement may be utilized to improve the flexibility of panoramic image capture beyond panning from a fixed position. In one illustrative example, a linear and/or scanning acquisition trajectory may be utilized to generate a panoramic image. In some examples, a very sparse collection of images (e.g., between two to ten images) captured from different viewpoints can be utilized to generate a partial 3D reconstruction of an environment. In some examples, a virtual camera can be utilized to render 2D images (e.g., using 3D reprojection) from different viewpoints within the partial 3D reconstruction of the environment.

Systems, apparatuses, processes (also referred to as methods), and computer-readable media (collectively referred to as “systems and techniques”) are described herein for identifying objects for removal from an image during an image capture process and removing the identified objects. In some cases, after one or more unwanted objects are identified for removal, additional preview images can be adjusted to remove the unwanted objects prior to capturing. In some examples, when an image of the scene is captured (e.g., in response to a capture input), the unwanted objects can be removed from the scene prior to storing an adjusted image in storage. For example, a photographer may be able to see an preview image that shows the unwanted object removed before pressing a shutter (or providing any other type of capture input).

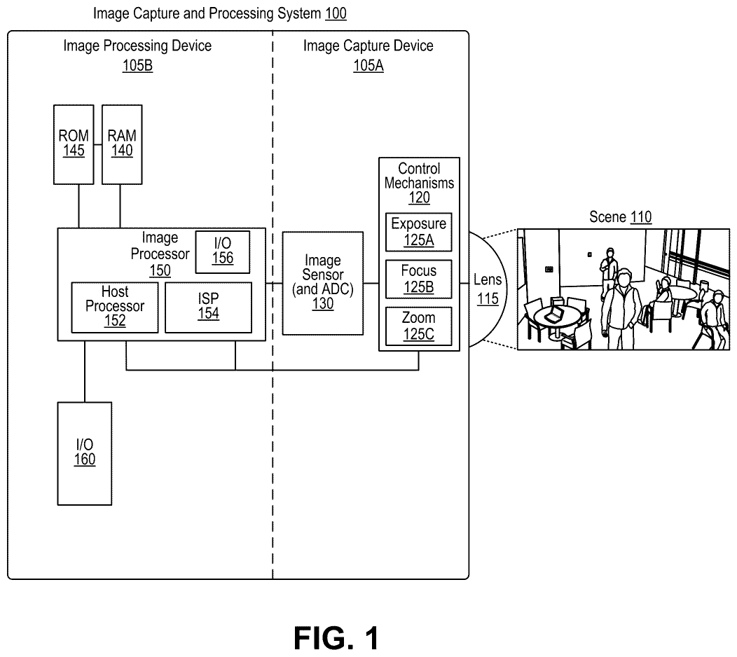

Various aspects of the techniques described herein will be discussed below with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors (e.g., image sensor 130) may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1210 discussed with respect to the computing system 1200. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (13C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of images to form an HDR image, image recognition, object recognition, feature recognition, receipt of inputs, managing outputs, managing memory, or some combination thereof. The image processor 150 may store image frames and/or processed images in random access memory (RAM) 140/3225, read-only memory (ROM) 145/1220, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1235, any other input devices 1245, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100. In some examples, the 3D image reconstruction and rendering system 300 can include the image capture and processing system 100, the image capture device 105A, the image processing device 105B, or a combination thereof.

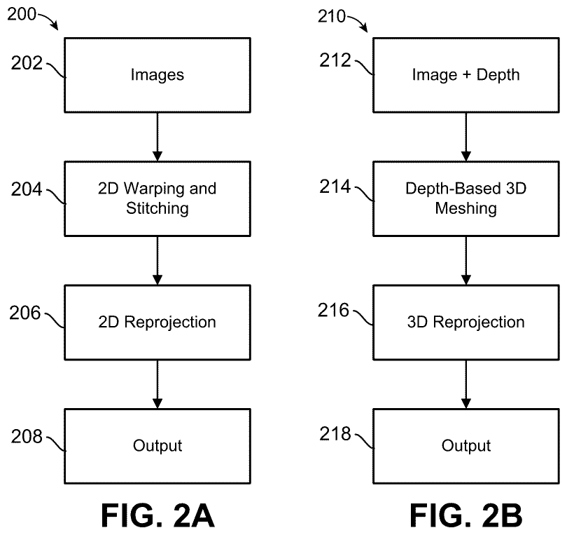

FIG. 2A is a diagram illustrating a process 200 for capturing panoramic images. At block 202, the process 200 includes obtaining images (e.g., from image capture and processing system 100 of FIG. 1). In some cases, the images can be captured by panning a camera at a fixed position.

At block 204, the process 200 can include 2D warping, stitching, stretching, distortion, and/or any other suitable techniques can be used to align edges of the captured images and combine the captured images.

At block 206, the process 200 can include 2D reprojection, which can be utilized to generate a panoramic image output 208 that appears to be captured from a novel viewpoint. For example, in the case of a 360 degree panoramic image, the rendered 2D image can be rendered from a desired center point of the panoramic image.

In some cases, conventional panoramic image capture techniques may not be able to tolerate any translation of the camera (e.g., image capture and processing system 100 of FIG. 1) during image acquisition. In some cases, any viewpoint shift resulting from translation of the camera can result in artifacts. In some aspects, such artifacts may not be corrected by 2D warping, stitching, stretching, distortion, or the like. In some implementations, 2D reprojection of the panoramic image output 208 may not support foreground parallax and/or camera motion. In one illustrative example, 2D reprojection may limited to panning motions around a fixed axis.

FIG. 2B is a diagram illustrating a process 210 for generating three-dimensional (3D) photographs. At block 212, the process 210 can include obtaining one or more images including depth information (e.g., RGB+depth images) from a camera (e.g., image capture and processing system 100 of FIG. 1). In some implementations, the process 210 can obtain on the order of 100 images with depth information. In some examples, the process 210 can obtain a single image with depth information.

At block 214, the process 210 can include generating a depth-based 3D mesh of an environment captured in the images including depth information. In some cases, a large number of images from different viewpoints may be required to accurately represent an environment within the 3D mesh. In some implementations, a single image with depth information may be used to generate a 3D mesh.

At block 216, the process 210 can include performing a 3D reprojection. For example, a virtual camera may be positioned at a desired viewpoint within the 3D mesh and the 3D environment can be projected into a 2D image captured by the virtual camera. In some examples, when multiple images with depth information are captured from a variety of different viewpoints, the virtual camera may be free to move with three degrees of freedom and/or six degrees of freedom within the 3D mesh. In some case, when the 3D mesh is generated based on a single image with depth information, a small amount of motion (e.g., +10 degrees of panning) of the virtual camera may be utilized to create the impression of a 3D image.

At block 218, the process 210 can include outputting a 2D image generated by the 3D reprojection into a 2D image.

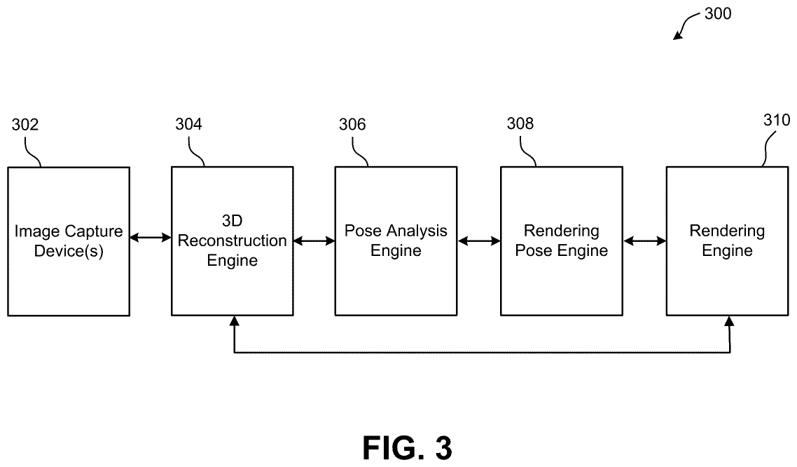

FIG. 3 is a block diagram illustrating an example of a 3D image reconstruction and rendering system 300. The 3D image reconstruction and rendering system 300 includes various components that are used to process one or more images, such as removing an unwanted feature or object in the one or more images. The 3D image reconstruction and rendering system 300 can generate a 3D reconstruction from a sparse collection of 2D images. In some examples, 2D images from novel viewpoints can be rendered based on the 3D reconstruction. As shown, the components of the 3D image reconstruction and rendering system 300 can include one or more image capture devices 302, a 3D reconstruction engine 304, a pose analysis engine 306, and a rendering pose engine 308, and a rendering engine 310.

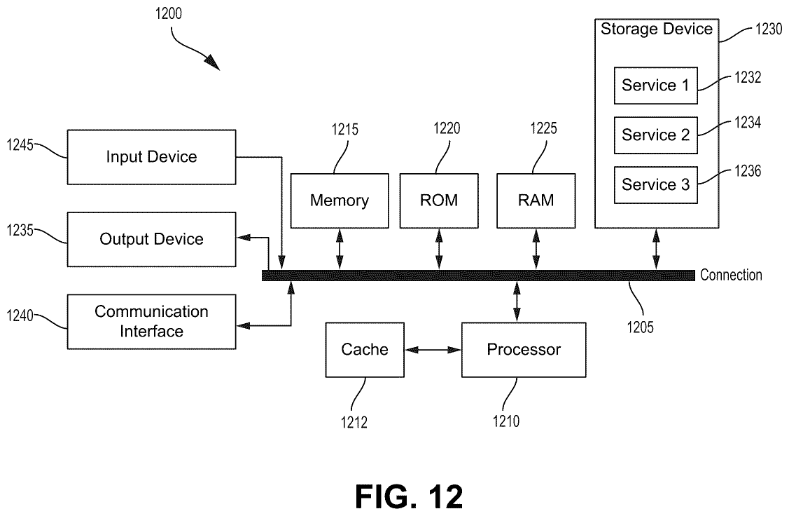

In some cases, the 3D image reconstruction and rendering system 300 can include or be part of a mobile or stationary telephone handset (e.g., smartphone, cellular telephone, or the like), a server computer (e.g., in communication with a vehicle computing system), a desktop computer, a laptop or notebook computer, a tablet computer, a set-top box, a television, a camera, a display device, a digital media player, a video streaming device, or any other suitable electronic device. In some examples, the 3D image reconstruction and rendering system 300 can include one or more wireless transceivers (or separate wireless receivers and transmitters) for wireless communications, such as cellular network communications, 802.11 Wi-Fi communications, wireless local area network (WLAN) communications, Bluetooth or other short-range communications, any combination thereof, and/or other communications. In some implementations, the components of the 3D image reconstruction and rendering system 300 (e.g., the one or more image capture devices 302, the 3D reconstruction engine 304, the pose analysis engine 306, rendering pose engine 308 and the rendering engine 310, can be part of the same computing device. In some implementations, the components of the 3D image reconstruction and rendering system 300 can be part of two or more separate computing devices. In some cases, the 3D image reconstruction and rendering system 300 can be implemented as part of the computing system 1200 shown in FIG. 12.

While the 3D image reconstruction and rendering system 300 is shown to include certain components, one of ordinary skill will appreciate that the 3D image reconstruction and rendering system 300 can include more components or fewer components than those shown in FIG. 3. In some cases, additional components of the 3D image reconstruction and rendering system 300 can include software, hardware, or one or more combinations of software and hardware. For example, in some cases, the 3D image reconstruction and rendering system 300 can include one or more other sensors (e.g., one or more inertial measurement units (IMUs), radars, light detection and ranging (LIDAR) sensors, audio sensors, etc.), one or more display devices, one or more other processing engines, one or more other hardware components, and/or one or more other software and/or hardware components that are not shown in FIG. 3. In some implementations, additional components of the 3D image reconstruction and rendering system 300 can include and/or can be implemented using electronic circuits or other electronic hardware, which can include one or more programmable electronic circuits (e.g., digital signal processors (DSPs), microprocessors, microcontrollers, graphics processing units (GPUs), central processing units (CPUs), any combination thereof, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the 3D image reconstruction and rendering system 300.

The one or more image capture devices 302 can capture one or more images. The one or more image capture devices 302 (e.g., cameras or other image sensors) can be included in a mobile device and can be directed toward a user of the device (e.g., with one or more front facing cameras) or directed away from the user of the device (e.g., with one or more rear facing cameras).

Each of the one or more image capture devices 302 can include a camera or other type of image sensor. In some examples, the one or more image capture devices 302 can include a camera configured to capture color images and/or monochrome images. The color images can include: red-green-blue (RGB) images; luma, chroma-blue, chroma-red (YCbCr or Y′CbCr) images; and/or any other suitable type of image. In one illustrative example, the one or more image capture devices 302 can include an RGB camera or multiple RGB cameras. In some cases, the one or more image capture devices 302 can include one or more IR cameras and one or more RGB cameras. In some examples, the one or more image capture devices 302 can include an infrared (IR) camera configured to capture IR images and/or near-infrared (NIR) images. For example, an IR camera or sensor can capture IR signals. IR signals have wavelengths and frequencies that fall in the IR electromagnetic spectrum. The IR electromagnetic spectrum includes wavelengths in the range of 2,500 nanometers (nm) to 1 millimeter (mm), corresponding to frequencies ranging from 430 terahertz (THz) to 400 gigahertz (GHz). The infrared spectrum includes the NIR spectrum, which includes wavelengths in the range of 780 nm to 2,500 nm. In some cases, the 3D image reconstruction and rendering system 300 can include an IR sensor configured to capture IR and NIR signals. In some cases, separate IR and NIR sensors can be included in the 3D image reconstruction and rendering system 300.

In some embodiments, the one or more image capture devices 302 can include one or more depth sensors. The one or more depth sensors can obtain measurements of distance corresponding to objects in a captured scene. In one illustrative example, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of objects. In some cases, the one or more depth sensors can produce depth images that include depth values corresponding to pixel locations in one or more images captured by the one or more image capture devices 302. In some cases, the depth sensor can be located in the same general location as other sensors of the one or more image capture devices 302. In some cases, the depth sensor can capture a depth image simultaneously with an image captured by one or more other sensors included in the one or more image capture devices 302. In some implementations, the systems and techniques described herein can also be used when depth information is inferred from the one or more images. As shown in FIG. 3, the one or more images captured by the one or more image capture devices 302 can be provided as input to the 3D reconstruction engine 304.

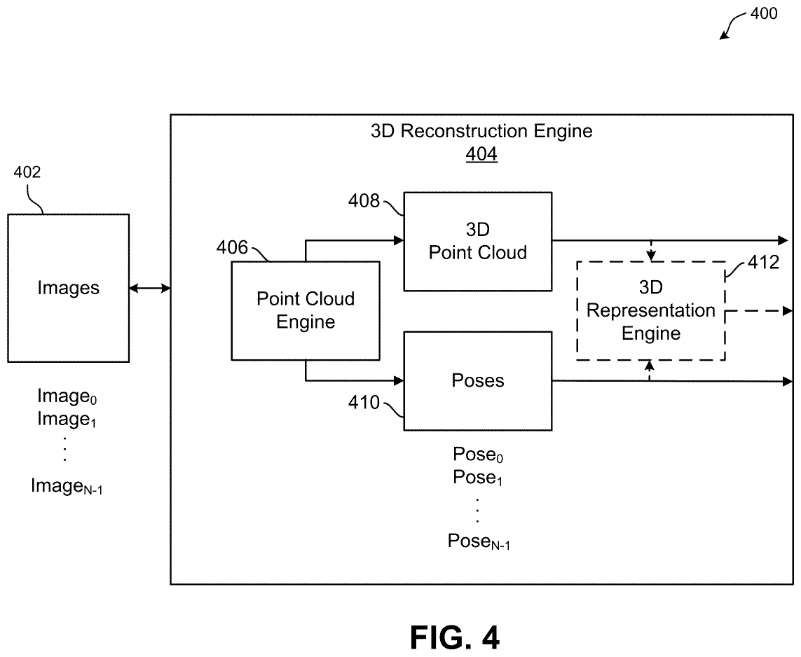

Referring to FIG. 4, an example configuration for a 3D reconstruction engine 404 is provided. In some cases, the 3D reconstruction engine 304 of FIG. 3 can correspond to the 3D reconstruction engine 404 of FIG. 4. As shown in FIG. 4, N images 402 (e.g., images from the one or more image capture devices 302 of FIG. 3), where Nis an integer, can be input into the 3D reconstruction engine 404. In some implementations, a point cloud engine 406 of the 3D reconstruction engine 404 may generate a 3D point cloud 408 and as well as poses 410 corresponding to each of the N images 402. For example, the 3D reconstruction engine 404 can generate pose, for image₀, pose₁ for image₁, a pose_{N-1} for image_{N-1} as well as a corresponding pose for any additional images of the N images 402. In some cases, the point cloud engine 406 may utilized a trained neural network model to generate the 3D point cloud 408 and the poses 410. In one illustrative example, the point cloud engine 406 may utilize 3D reconstruction (e.g., dense and unconstrained stereo 3D reconstruction) such as that described in Shuzhe Wang et al., “DUSt3R: Geometric 3D Vision Made Easy,” 2023, which is hereby incorporated by reference in its entirety and for all purposes. However, it should be understood that additional techniques for generating 3D point clouds and/or generating poses from still images may be utilized without departing from the scope of the present disclosure.

In some implementations, the 3D reconstruction engine 404 may output the 3D point cloud 408 and poses 410 to a rendering engine (e.g., rendering engine 310 of FIG. 3). For example, if the rendering engine utilizes point cloud rendering, the 3D point cloud and poses 410 may provide sufficient information to render images from novel viewpoints.

In some cases, the 3D reconstruction may include a 3D representation engine 412. In some examples, the 3D representation engine 412 may process the 3D point cloud 408 and/or poses 410 to generate a 3D representation having different and/or additional features. For example, while the 3D point cloud may represent the environment as individual points, the 3D representation engine 412 may be utilized to generate a 3D mesh, 3D gaussians, neural radiance fields (NeRF), volume rendering, and/or any other suitable 3D representation.

Returning to FIG. 3, outputs of 3D reconstruction engine 304 (e.g., 3D reconstruction engine 404) can be provided to the pose analysis engine 306 and the rendering engine 310 of the 3D image reconstruction and rendering system 300. In some implementations, the pose analysis engine 306 may determine a type of acquisition based on the poses (e.g., poses 410) output by the 3D reconstruction engine 304.

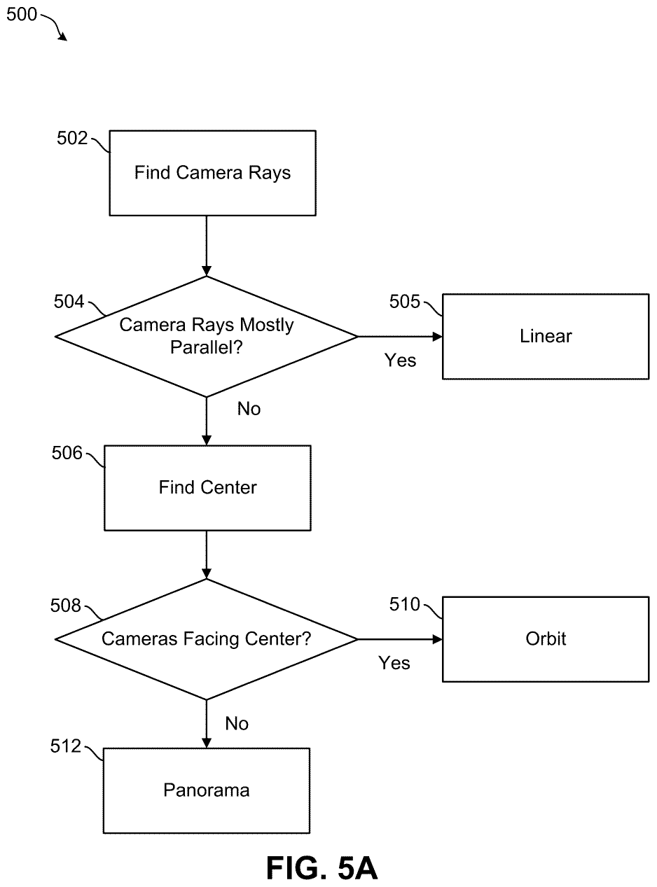

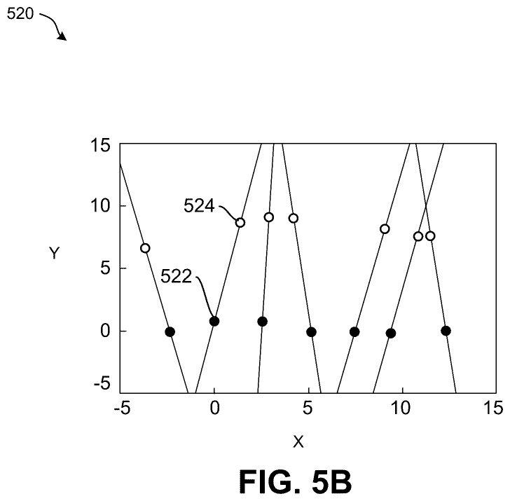

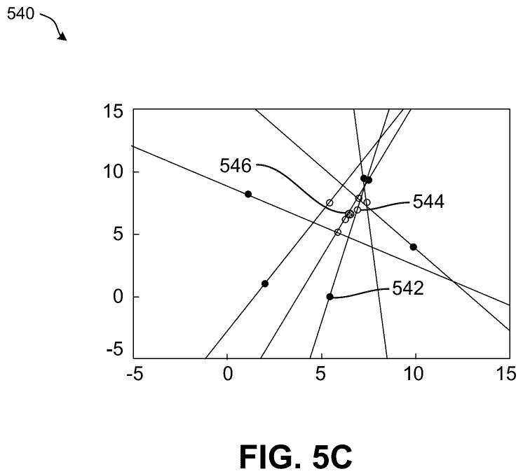

FIG. 5A is a flow diagram illustrating an example process 500 for performing pose analysis. In some cases, the pose analysis process can be performed by the pose analysis engine 306 of FIG. 3. At block 502, the process 500 includes determining camera rays corresponding to each image provided by the image capture devices (e.g., N images 402 of FIG. 4). In some cases, the camera rays may be determined based on the poses (e.g., poses 410 of FIG. 4) provided by the 3D reconstruction engine 304. In some examples, the camera rays may be represented by a center of projection and a pointing direction.

At block 504, the process 500 includes determining whether the camera rays found at block 502 are mostly parallel. For example, determining whether the camera rays are mostly parallel can include determining cosine similarity between the various camera rays. In some cases, if the process 500 determines at block 504 that the camera rays are mostly parallel, the process 500 can proceed to block 505.

FIG. 5B is a diagram 520 illustrating example poses for a linear trajectory. In the example of FIG. 5B, camera origin points 522 are represented by black filled circles. In some cases, target points 524 represented by hollow circles can represent a location of an image target captured in each of the images. However, in some cases, the target points 524 may simply be indicative of a pointing direction of the camera rays. In the example of FIG. 5B, the camera camera origin points may be indicative of a camera traveling along the X-axis direction with a pointing direction toward the positive Y-axis direction with slight variations in pointing direction as the camera traverses along the X-axis. In some cases, based on the camera rays shown in FIG. 5B, the process 500 can determine that the camera rays are mostly parallel and proceed to block 505. At block 505, the process 500 can conclude that the camera rays correspond to a linear trajectory.

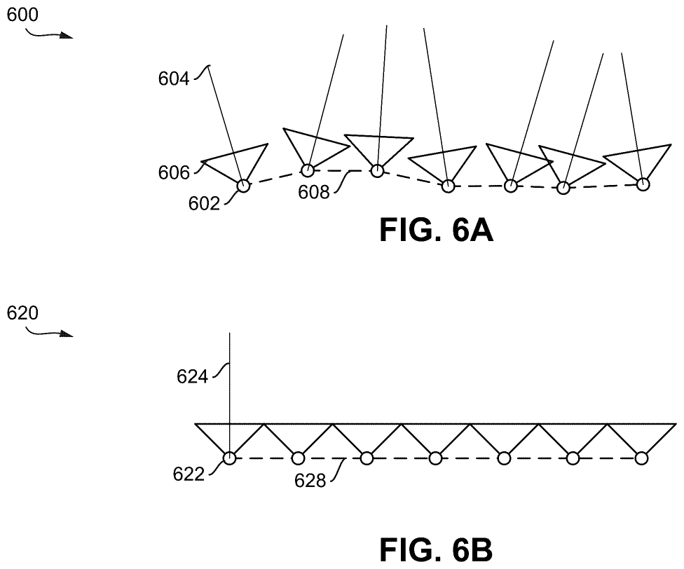

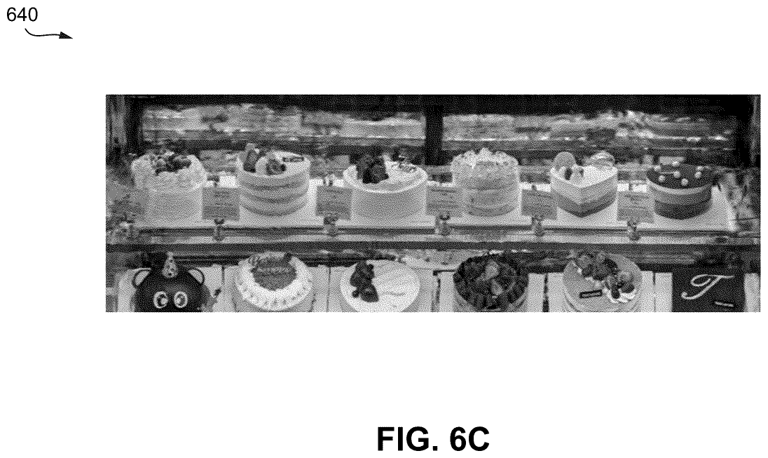

FIG. 6A is a diagram 600 illustrating example camera rays for a linear trajectory. In the example of FIG. 6A, camera rays for each image in a sequence of images can be represented by a center of projection 602, a pointing direction 604, and a field of view (FOV) 606. In the example of FIG. 6A, a piece-wise trajectory 608 is also shown between captured images to represent the linear trajectory. In some cases, based on the camera rays illustrated in FIG. 6A, the process 500 can determine that the camera rays are mostly parallel and proceed to block 505.

Returning to FIG. 5A, if the process 500 determines at block 504 that the camera rays are not mostly parallel, the process 500 can proceed to block 506. In some cases, the process 500 can determine a center point corresponding to the collection of camera rays. For example, a center point may be determined by performing a least squares analysis on the centers of projection and/or the targets associated with the collection of camera rays.

FIG. 5C is a diagram 540 illustrating example poses for an orbital acquisition or a panoramic acquisition. In the case of an orbital acquisition, the points 542 represented by black filled circles can correspond to centers of projection for images captured by the one or more image capture devices and provided to the 3D image reconstruction and rendering system 300 of FIG. 3. Further in the example of FIG. 5C, for the case of an orbital acquisition, the points 544 represented by hollow circles can correspond to target points corresponding to the camera arrays determined based on the input images (e.g., N images 402 of FIG. 4).

In the case of a panoramic acquisition, the points 542 represented by black filled circles can correspond to target points while the points 544 represented by hollow circles can correspond to centers of projection.

Returning to FIG. 5A, at block 506, the process 500 can determine the center point (e.g., center point 546 of FIG. 5C) and output the center point to block 508. In some implementations, the center point (e.g., center point 546 of FIG. 5C) can be determined based on a least squares algorithm. In some examples, any other suitable algorithm for determining a center point of the camera rays may be used without departing from the scope of the present disclosure.

At block 508, the process 500 can determine whether the camera rays are facing toward the center point or away from the center point determined at block 506. In some cases, based on determining that the camera rays are pointing toward center point 546 (e.g., for an orbital acquisition), the process 500 can proceed to block 510. At block 510, the process 500 can determine that the camera rays correspond to an orbital acquisition.

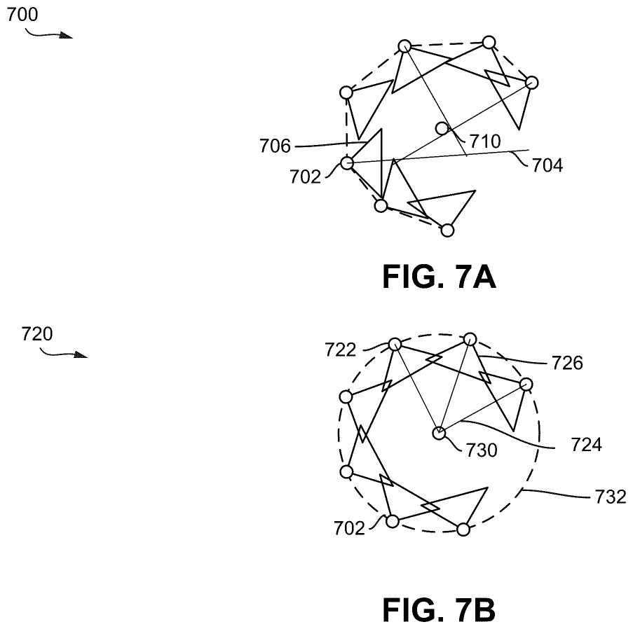

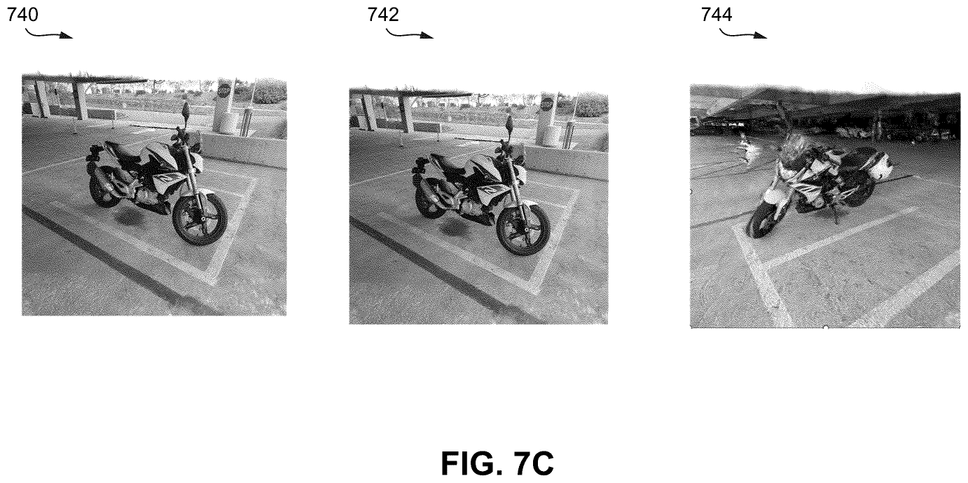

FIG. 7A is a diagram 700 illustrating example camera rays for an orbital acquisition. In the example of FIG. 7A, camera rays corresponding to determined poses (e.g., poses 410 of FIG. 4) for input images (e.g., N images 402 of FIG. 4) are each represented by a respective center of projection 702 and/or pointing direction 704. In the example of FIG. 7A, a representation of the FOV 706 for each of the camera rays is also shown. In the example of FIG. 7A, each of the camera rays is illustrated facing toward the direction of the center point 710.

Returning to FIG. 5A, in some cases, based on determining that the camera rays are facing toward the direction of the center point (e.g., center point 710 of FIG. 7A), the process 500 can determine that the camera rays correspond to the orbital acquisition and proceed to block 510.

In some examples, if the process 500 determines at block 508 that the camera rays are pointing away from the center (e.g., away from center point 546 of FIG. 5C), then the process 500 can proceed to block 512. At block 512, the process 500 can determine that the camera rays correspond to a panoramic acquisition.

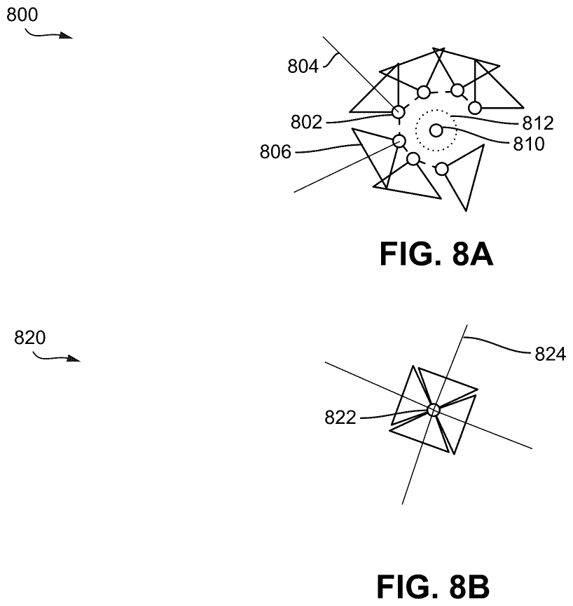

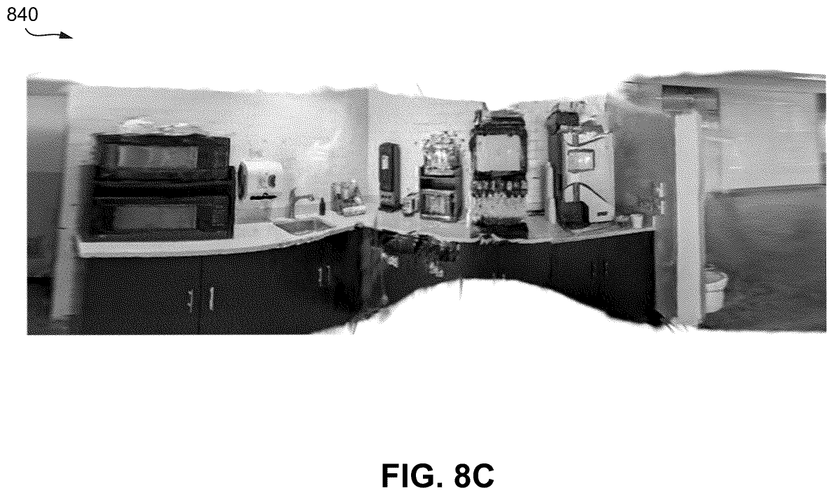

FIG. 8A is a diagram 800 illustrating example camera rays for a panoramic acquisition. In the example of FIG. 8A, camera rays corresponding to determined poses (e.g., poses 410 of FIG. 4) for input images (e.g., N images 402 of FIG. 4) are each represented by a respective center of projection 802 and pointing direction 804. FIG. 8A further illustrates example FOVs 806 for the camera rays. In the example of FIG. 8A, each of the camera rays is illustrated facing away from the direction of the center point 810. In one illustrative example, the camera rays shown in FIG. 8A can correspond to a panoramic capture in which a pillar 812 (or other obstruction) would potentially obscure a portion of a conventional panoramic capture.

Returning to FIG. 5A, in some cases, based on determining that the camera rays are facing away from the direction of the center point (e.g., center point 810 of FIG. 8A), the process 500 can determine that the camera rays correspond to the panoramic acquisition and proceed to block 512.

Returning to FIG. 3, the pose analysis engine 306 (e.g., by process 500 of FIG. 5A) may determine that images are consistent with a particular capture type, such as a linear trajectory, an orbital acquisition, or a panoramic acquisition. As illustrated in FIG. 3, the capture type determined by the pose analysis engine 306 may be provided to the rendering pose engine 308. In some aspects, the determined capture type may be associated with a particular user intention for a sequence of images.

In some examples, the rendering pose engine 308 may obtain the capture type determined by the pose analysis engine 306 and generate rendering poses consistent with the determined capture type. For example, if the pose analysis engine 306 determines that the camera rays are consistent with a linear trajectory capture type, the rendering pose engine 308 may generate rendering poses that have a consistent pointing direction and/or rendering poses that have a trajectory along a straight line path.

FIG. 6B is a diagram 620 illustrating example rendering poses for the linear trajectory of FIG. 6A. In some cases, the rendering poses illustrated in FIG. 6B can correspond to rendering poses generated by the rendering pose engine 308 of FIG. 3 for a linear trajectory capture type. As shown in FIG. 6B, each of the rendering poses can include a center of projection 622 and a pointing direction 624. In the example of FIG. 6B, each of the rendering poses can have an identical pointing direction. In some cases, the centers of projection 622 may be generated along a linear path 628 associated with the linear trajectory. In some implementations, the rendering poses of FIG. 6B can represent rendering poses that can be used to generate a 2D panoramic image corresponding to the linear trajectory. In some aspects, the rendering poses of FIG. 6B may be utilized for rendering a panoramic image.

Returning to FIG. 3, in some cases, if the pose analysis engine 306 determines that the camera rays are consistent with an orbital acquisition, the rendering pose engine 308 may generate rendering poses for rendering a portion of an environment from different rendering poses facing toward a common center point.

FIG. 7B is a diagram 720 illustrating rendering poses for the example orbital acquisition of FIG. 7A. In the example of FIG. 7B, rendering poses can include a center of projection 722 and/or a pointing direction 724. FIG. 7B further illustrates a portion of the FOVs 726 associated with each of the rendering poses. In the example of FIG. 7B, the pointing directions 724 for each of the rendering poses points toward a common center point 730. In some implementatinops, the common center point 730 can correspond to the center point 710 of the orbital acquisition of FIG. 7A. In some implementations, the center of projection 722 for each of the rendering poses can be positioned along a circle 732 centered at the common center point 730. In some aspects, the circle 732 can have an orbital radius and the rendering poses can be positioned radially around at least a portion of the circle 732. However, in some examples (not shown), the center of projection 722 for each of the rendering poses may be positioned along other shapes, such as an ellipse centered at the common center point 730, or the like. In the example of FIG. 7B, the rendering poses shown represent a subset of rendering poses that can be used to render the 3D representation (e.g., from the 3D reconstruction engine 304 of FIG. 3).

Returning to FIG. 3, in some cases, if the pose analysis engine 306 determines that the camera rays are consistent with a panoramic acquisition, the rendering pose engine 308 may generate rendering poses for rendering a portion of scene from the common center point facing outwardly in different directions.

FIG. 8B is a diagram 820 illustrating rendering poses for the example panoramic acquisition of FIG. 8A. In the example of FIG. 8B, each of the rendering poses can share a common center of projection 822. As shown in FIG. 8B, the common center of projection 822 can correspond to the center point 810 of the camera rays of FIG. 8A. In the example of FIG. 8B, the rendering poses shown represent a subset of rendering poses that can be used to render a 3D representation (e.g., from the 3D reconstruction engine 304 of FIG. 3) of an environment (e.g., a scene).

Returning to FIG. 3, in some cases, the rendering pose engine 308 may obtain one or more desired poses for rendering a 3D environment. In one illustrative example, the rendering pose engine 308 may obtain one or more desired poses based on a user input (e.g., a user interface). For example, the rendering pose engine 308 may obtain user input to simulate movement within a simulated 3D environment.

In some implementations, rendering engine 310 of the 3D image reconstruction and rendering system 300 may obtain outputs from the 3D reconstruction engine 304 and the rendering pose engine 308. For example, the rendering engine 310 may obtain a 3D point cloud (e.g., 3D point cloud 408 of FIG. 4) and/or a 3D representation (e.g., from the 3D representation engine 412 of FIG. 4) from the 3D reconstruction engine 304. In some cases, the rendering engine 310 may obtain one or more rendering poses (e.g., camera views shown in FIG. 7B, 8B, and/or 9B) from the rendering pose engine 308. In some cases, the rendering engine 310 may perform a 3D reprojection of the 3D representation of the environment.

In some cases, the rendering engine 310 may obtain multiple rendering poses that can be used to generate a panoramic image. Referring to FIG. 6C, the panoramic image 640 may be a result of rendering from each of the camera views (e.g., centers of projection 622 and pointing directions 624) for the linear trajectory of FIG. 6A and FIG. 6B and combining the rendered images into a single panoramic image. Referring to FIG. 8C, the panoramic image 840 may be a result of rendering from each of the camera views (e.g., common center of projection 822 and pointing directions 824) for the panoramic acquisition of FIG. 8A and FIG. 8B and combining the rendered images into a single panoramic image.

In some implementations, the rendering engine 310 may receive pose inputs and dynamically render a 3D reprojection of the 3D environment (e.g., obtained from the 3D reconstruction engine). Referring to FIG. 7C, the images 740, 742, and 744 may correspond to images rendered with different rendering poses for the orbital acquisition of FIG. 7A and FIG. 7C. As noted above, in some cases, the rendering poses may be obtained as an input (e.g., from a user interface). As noted above, in some aspects, rendering images from different input rendering poses may be utilized to simulate movement within a simulated 3D environment (also referred to herein as a 3D interactive rendering).

In some cases, utilizing rendering poses that are similar to the camera views used to acquire images can provide higher quality images relative to rendering poses that deviate from the camera views (e.g., centers of projection and/or pointing directions) used during image acquisition.

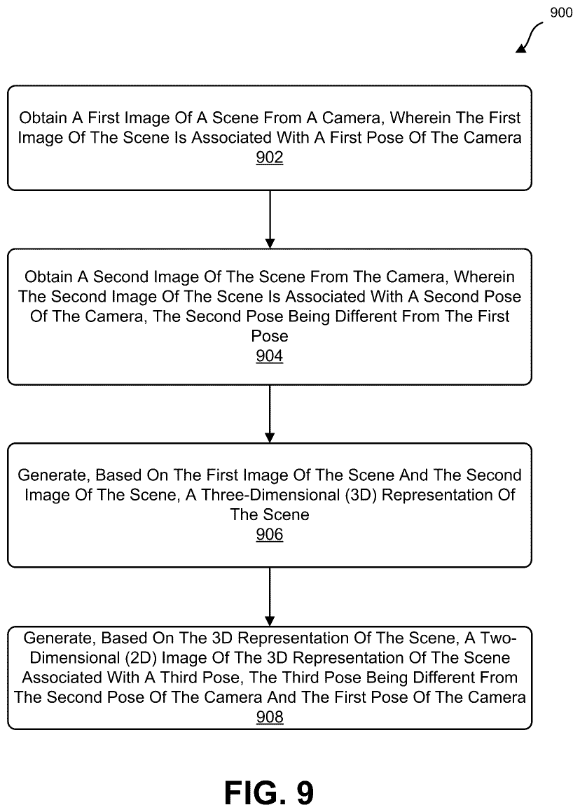

FIG. 9 is a flow diagram of a process 900. The process 900 may be performed by a computing device (or apparatus) or a component (e.g., a chipset, codec, etc.) of the computing device. The computing device may be a mobile device, a network-connected wearable such as a watch, an XR device such as a VR device or AR device, a vehicle or component or system of a vehicle, a network node/entity/device, wireless device, or other type of computing device. The operations of the process 900 may be implemented as software components that are executed and run on one or more processors.

At block 902, the computing device (or component thereof) may obtain a first image of a scene from a camera. In some cases, the first image (e.g., n images 402 of FIG. 4) of the scene is associated with a first pose (e.g., a pose associated with a center of projection 602 and pointing direction 604 of FIG. 6A, a pose associated with a center of projection 702 and pointing direction 704 of FIG. 7A, a pose associated with a center of projection 802 and pointing direction 804 of FIG. 8A) of the camera (e.g., image capture and processing system 100 of FIG. 1, one or more image capture devices 302 of FIG. 3).

At block 904, the computing device (or component thereof) may obtain a second image of the scene from the camera. In some examples, the second image (e.g., n images 402 of FIG. 4) of the scene is associated with a second pose of the camera (e.g., a pose associated with a center of projection 602 and pointing direction 604 of FIG. 6A, a pose associated with a center of projection 702 and pointing direction 704 of FIG. 7A, a pose associated with a center of projection 802 and pointing direction 804 of FIG. 8A), the second pose being different from the first pose.

At block 906, the computing device (or component thereof) may generate (e.g., by 3D representation engine 412 of FIG. 4), based on the first image of the scene and the second image of the scene, a 3D representation of the scene.

At block 908, the computing device (or component thereof) may generate (e.g., by 3D representation engine 412 of FIG. 4), based on the 3D representation of the scene, a 2D image of the 3D representation of the scene associated with a third pose, the third pose being different from the second pose of the camera and the first pose of the camera.

In some examples, the computing device (or component thereof) may determine, based on the first pose of the camera and the second pose of the camera, a capture type associated with the first pose of the camera and the second pose of the camera.

In some cases, to determine the capture type associated with the first pose of the camera and the second pose of the camera, the computing device (or component thereof) may determine whether a trajectory associated with the first pose of the camera, the second pose of the camera, and at least one additional pose of the camera corresponds to a panoramic linear trajectory (e.g., as shown in FIG. 6A). In some examples, the computing device (or component thereof) may determine, based on determining that the trajectory associated with the first pose of the camera, the second pose of the camera, and the at least one additional pose of the camera corresponds to the panoramic linear trajectory, a plurality of rendering viewpoints (e.g., centers of projection 622 and pointing directions 624 of FIG. 6A) for rendering the 3D representation of the scene. In some examples, the computing device (or component thereof) may render a 2D panoramic image (e.g., panoramic image 640 of FIG. 6C) based on the 3D representation of the scene. In some implementations, the computing device (or component thereof) may generate a 3D interactive rendering (e.g., simulating motion within the 3D representation) of the 3D representation of the scene along a linear path. In some cases, to determine the linear path the computing device (or component thereof) may perform a linear regression of the first pose of the camera, the second pose of the camera, and the at least one additional pose of the camera; and align the plurality of rendering viewpoints to a shared view direction.

In some cases, to determine the capture type associated with the first pose of the camera and the second pose of the camera, the computing device (or component thereof) may determine whether a trajectory associated with the first pose of the camera, the second pose of the camera, and at least one additional pose of the camera corresponds to a panoramic orbital acquisition (e.g., as shown in FIG. 7A). In some examples, to determine the region of interest associated with the panoramic orbital acquisition, the computing device (or component thereof) may regress a center point (e.g., center point 710 of FIG. 7A) of the first pose of the camera, the second pose of the camera, and the at least one additional pose of the camera. In some implementations, the computing device (or component thereof) may determine, based on determining that the trajectory associated with the first pose of the camera, the second pose of the camera, and the at least one additional pose of the camera corresponds to the panoramic orbital acquisition, an orbital radius associated with the panoramic orbital acquisition. In some examples, the computing device (or component thereof) may generate a 3D interactive rendering of the 3D representation of the scene. In some aspects, generating the 3D interactive rendering includes capturing images of the 3D representation of the scene with a virtual camera from a plurality of viewpoints along the orbital radius.

In some cases, to determine the capture type associated with the first pose of the camera and the second pose of the camera, the computing device (or component thereof) may determine whether a trajectory associated with the first pose of the camera, the second pose of the camera, and at least one additional pose of the camera corresponds to a panoramic acquisition (e.g., as shown in FIG. 8A) determine, based on determining that the trajectory associated with the first pose of the camera, the second pose of the camera, and the at least one additional pose of the camera corresponds to the panoramic linear trajectory, a plurality of rendering viewpoints for rendering the 3D representation of the scene. In some examples, the computing device (or component thereof) may determine, based on determining that the trajectory associated with the first pose of the camera, the second pose of the camera, and the at least one additional pose of the camera corresponds to the panoramic acquisition, a center of projection (e.g., center point 810 of FIG. 8A) associated with the panoramic acquisition. In some implementations, to determine the center of projection associated with the panoramic acquisition, the computing device (or component thereof) may regress a center point of the first pose of the camera, the second pose of the camera, and the at least one additional pose of the camera.

In some examples, the processes described herein (e.g., process 500, process 900 and/or other process described herein) may be performed by a computing device or apparatus. In one example, one or more of the processes can be performed by the 3D image reconstruction and rendering system 300 of FIG. 3. In another example, one or more of the processes can be performed by the computing system 1200 shown in FIG. 12. For instance, a computing device with the computing system 1200 shown in FIG. 12 can include the components of the 3D image reconstruction and rendering system 300 and can implement the operations of the process 500 of FIG. 5A, the process 900 of FIG. 9 and/or other process described herein.

The computing device can include any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including the process 900 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 500 and process 900 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500, the process 900, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

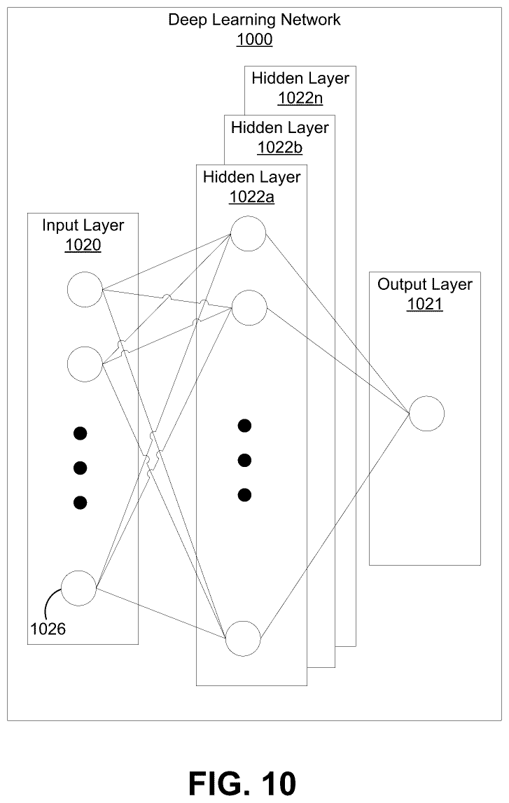

As noted above, various aspects of the present disclosure can use machine learning models or systems. FIG. 10 is an illustrative example of a deep learning neural network 1000 that can be used to implement the machine learning based feature segmentation, instance segmentation, depth estimation and/or classification described above. An input layer 1020 includes input data. In one illustrative example, the input layer 1020 can include data representing the pixels of an input image. The neural network 1000 includes multiple hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. The neural network 1000 further includes an output layer 1021 that provides an output resulting from the processing performed by the hidden layers 1022a, 1022b, through 1022n. In one illustrative example, the output layer 1021 can provide a classification for an object in an input image (e.g., N images 402 of FIG. 4). The classification can include a class identifying the type of activity (e.g., looking up, looking down, closing eyes, yawning, etc.).

The neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the first hidden layer 1022a can transform the information of each input node by applying activation functions to the input node information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1021, at which an output is provided. In some cases, while nodes (e.g., node 1026) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. Once the neural network 1000 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1020 using the different hidden layers 1022a, 1022b, through 1022n in order to provide the output through the output layer 1021. In an example in which the neural network 1000 is used to identify features in images, the neural network 1000 can be trained using training data that includes both images and labels, as described above. For instance, training images can be input into the network, with each training image having a label indicating the features in the images (for the feature segmentation machine learning system) or a label indicating classes of an activity in each image. In one example using object classification for illustrative purposes, a training image can include an image of a number 2, in which case the label for the image can be [00 1000000 0].

In some cases, the neural network 1000 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 1000 is trained well enough so that the weights of the layers are accurately tuned.

For the example of identifying objects in images, the forward pass can include passing a training image through the neural network 1000. The weights are initially randomized before the neural network 1000 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 1000, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1000 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1000 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 1000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1000 can include any other deep network other than a CNN, such as an autoencoder, a deep belief nets (DBNs), a Recurrent Neural Networks (RNNs), among others.

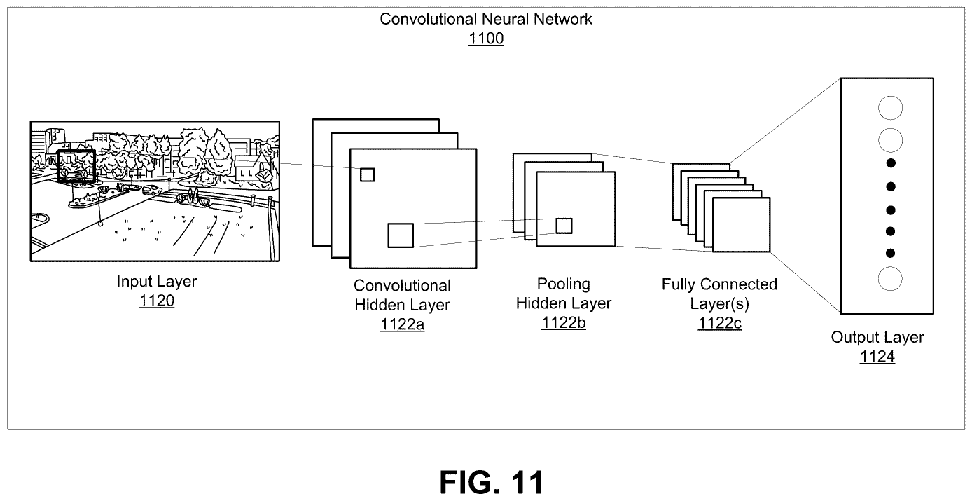

FIG. 11 is an illustrative example of a convolutional neural network (CNN) 1100. The input layer 1120 of the CNN 1100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1122a, an optional non-linear activation layer, a pooling hidden layer 1122b, and fully connected hidden layers 1122c to get an output at the output layer 1124. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 is the convolutional hidden layer 1122a. The convolutional hidden layer 1122a analyzes the image data of the input layer 1120. Each node of the convolutional hidden layer 1122a is connected to a region of nodes (pixels) of the input image called a receptive field. The convolutional hidden layer 1122a can be considered as one or more filters (each filter corresponding to a different activation or feature map), with each convolutional iteration of a filter being a node or neuron of the convolutional hidden layer 1122a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1122a. Each connection between a node and a receptive field for that node learns a weight and, in some cases, an overall bias such that each node learns to analyze its particular local receptive field in the input image. Each node of the hidden layer 1122a will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1122a is due to each node of the convolutional layer being applied to its corresponding receptive field. For example, a filter of the convolutional hidden layer 1122a can begin in the top-left corner of the input image array and can convolve around the input image. As noted above, each convolutional iteration of the filter can be considered a node or neuron of the convolutional hidden layer 1122a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1122a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1122a.

The mapping from the input layer to the convolutional hidden layer 1122a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1122a can include several activation maps in order to identify multiple features in an image. The example shown in FIG. 11 includes three activation maps. Using three activation maps, the convolutional hidden layer 1122a can detect three different kinds of features, with each feature being detectable across the entire image.

In some examples, a non-linear hidden layer can be applied after the convolutional hidden layer 1122a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1100 without affecting the receptive fields of the convolutional hidden layer 1122a. The pooling hidden layer 1122b can be applied after the convolutional hidden layer 1122a (and after the non-linear hidden layer when used). The pooling hidden layer 1122b is used to simplify the information in the output from the convolutional hidden layer 1122a. For example, the pooling hidden layer 1122b can take each activation map output from the convolutional hidden layer 1122a and generates a condensed activation map (or feature map) using a pooling function. Max-pooling is one example of a function performed by a pooling hidden layer. Other forms of pooling functions be used by the pooling hidden layer 1122a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1122a. In the example shown in FIG. 11, three pooling filters are used for the three activation maps in the convolutional hidden layer 1122a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1122a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1122a having a dimension of 24×24 nodes, the output from the pooling hidden layer 1122b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1122b to every one of the output nodes in the output layer 1124. Using the example above, the input layer includes 28×28 nodes encoding the pixel intensities of the input image, the convolutional hidden layer 1122a includes 3×24×24 hidden feature nodes based on application of a 5×5 local receptive field (for the filters) to three activation maps, and the pooling hidden layer 1122b includes a layer of 3×12×12 hidden feature nodes based on application of max-pooling filter to 2×2 regions across each of the three feature maps. Extending this example, the output layer 1124 can include ten output nodes. In such an example, every node of the 3×12×12 pooling hidden layer 1122b is connected to every node of the output layer 1124.

The fully connected layer 1122c can obtain the output of the previous pooling hidden layer 1122b (which should represent the activation maps of high-level features) and determines the features that most correlate to a particular class. For example, the fully connected layer 1122c layer can determine the high-level features that most strongly correlate to a particular class, and can include weights (nodes) for the high-level features. A product can be computed between the weights of the fully connected layer 1122c and the pooling hidden layer 1122b to obtain probabilities for the different classes. For example, if the CNN 1100 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1124 can include an M-dimensional vector (in the prior example, M=10). M indicates the number of classes that the CNN 1100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 00.150000], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“=”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application-n specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1: An apparatus for processing one or more images, comprising: at least one memory; and at least one processor coupled to the at least one memory and configured to: obtain a first image of a scene from a camera, wherein the first image of the scene is associated with a first pose of the camera; obtain a second image of the scene from the camera, wherein the second image of the scene is associated with a second pose of the camera, the second pose being different from the first pose; generate, based on the first image of the scene and the second image of the scene, a 3D representation of the scene; and generate, based on the 3D representation of the scene, a 2D image of the 3D representation of the scene associated with a third pose, the third pose being different from the second pose of the camera and the first pose of the camera.
Aspect 2: The apparatus of Aspect 1, wherein the at least one processor is further configured to: determine, based on the first pose of the camera and the second pose of the camera, a capture type associated with the first pose of the camera and the second pose of the camera.
Aspect 3: The apparatus of Aspect 2, wherein, to determine the capture type associated with the first pose of the camera and the second pose of the camera, the at least one processor is configured to determine whether a trajectory associated with the first pose of the camera, the second pose of the camera, and at least one additional pose of the camera corresponds to a panoramic linear trajectory.
Aspect 4: The apparatus of Aspect 3, wherein the at least one processor is further configured to determine, based on determining that the trajectory associated with the first pose of the camera, the second pose of the camera, and the at least one additional pose of the camera corresponds to the panoramic linear trajectory, a plurality of rendering viewpoints for rendering the 3D representation of the scene.
Aspect 5: The apparatus of Aspect 4, wherein the at least one processor is further configured to render a 2D panoramic image based on the 3D representation of the scene.
Aspect 6: The apparatus of Aspect 4, wherein the at least one processor is further configured to generate a 3D interactive rendering of the 3D representation of the scene along a linear path.
Aspect 7: The apparatus of Aspect 6, wherein, to determine the linear path, the at least one processor is configured to: perform a linear regression of the first pose of the camera, the second pose of the camera, and the at least one additional pose of the camera; and align the plurality of rendering viewpoints to a shared view direction.
Aspect 8: The apparatus of Aspect 2, wherein, to determine the capture type associated with the first pose of the camera and the second pose of the camera, the at least one processor is configured to determine whether a trajectory associated with the first pose of the camera, the second pose of the camera, and at least one additional pose of the camera corresponds to a panoramic orbital acquisition.
Aspect 9: The apparatus of Aspect 8, wherein the at least one processor is further configured to determine, based on determining that the trajectory associated with the first pose of the camera, the second pose of the camera, and the at least one additional pose of the camera corresponds to the panoramic orbital acquisition, a region of interest associated with the panoramic orbital acquisition.
Aspect 10: The apparatus of Aspect 9, wherein, to determine the region of interest associated with the panoramic orbital acquisition, the at least one processor is configured to regress a center point of the first pose of the camera, the second pose of the camera, and the at least one additional pose of the camera.
Aspect 11: The apparatus of Aspect 8, wherein the at least one processor is further configured to determine, based on determining that the trajectory associated with the first pose of the camera, the second pose of the camera, and the at least one additional pose of the camera corresponds to the panoramic orbital acquisition, an orbital radius associated with the panoramic orbital acquisition.
Aspect 12: The apparatus of Aspect 11, wherein the at least one processor is further configured to generate a 3D interactive rendering of the 3D representation of the scene, wherein generating the 3D interactive rendering comprises capturing images of the 3D representation of the scene with a virtual camera from a plurality of viewpoints along the orbital radius.
Aspect 13: The apparatus of Aspect 2, wherein, to determine the capture type associated with the first pose of the camera and the second pose of the camera, the at least one processor is configured to determine whether a trajectory associated with the first pose of the camera, the second pose of the camera, and at least one additional pose of the camera corresponds to a panoramic acquisition.
Aspect 14: The apparatus of Aspect 13, wherein the at least one processor is further configured to determine, based on determining that the trajectory associated with the first pose of the camera, the second pose of the camera, and the at least one additional pose of the camera corresponds to the panoramic acquisition, a center of projection associated with the panoramic acquisition.
Aspect 15: The apparatus of Aspect 14, wherein, to determine the center of projection associated with the panoramic acquisition, the at least one processor is configured to regress a center point of the first pose of the camera, the second pose of the camera, and the at least one additional pose of the camera.
Aspect 16: A method for processing one or more images, the method comprising: obtaining a first image of a scene from a camera, wherein the first image of the scene is associated with a first pose of the camera; obtaining a second image of the scene from the camera, wherein the second image of the scene is associated with a second pose of the camera, the second pose being different from the first pose; generating, based on the first image of the scene and the second image of the scene, a 3D representation of the scene; and generating, based on the 3D representation of the scene, a 2D image of the 3D representation of the scene associated with a third pose, the third pose being different from the second pose of the camera and the first pose of the camera.
Aspect 17: The method of Aspect 16, further comprising determining, based on the first pose of the camera and the second pose of the camera, a capture type associated with the first pose of the camera and the second pose of the camera.
Aspect 18: The method of Aspect 17, wherein determining the capture type comprises determining whether a trajectory associated with the first pose of the camera, the second pose of the camera, and at least one additional pose of the camera corresponds to a panoramic linear trajectory.
Aspect 19: The method of Aspect 18, further comprising determining, based on determining that the trajectory associated with the first pose of the camera, the second pose of the camera, and the at least one additional pose of the camera corresponds to the panoramic linear trajectory, a plurality of rendering viewpoints for rendering the 3D representation of the scene.
Aspect 20: The method of Aspect 19, further comprising rendering a 2D panoramic image based on the 3D representation of the scene.
Aspect 21: The method of Aspect 19, further comprising generating 3D interactive rendering of the 3D representation of the scene along a linear path.
Aspect 22: The method of Aspect 21, wherein determining the linear path comprises: performing a linear regression of the first pose of the camera, the second pose of the camera, and the at least one additional pose of the camera; and aligning the plurality of rendering viewpoints to a shared view direction.
Aspect 23: The method of Aspect 17, wherein determining the capture type comprises determining whether a trajectory associated with the first pose of the camera, the second pose of the camera, and at least one additional pose of the camera corresponds to a panoramic orbital acquisition.
Aspect 24: The method of Aspect 23, further comprising determining, based on determining that the trajectory associated with the first pose of the camera, the second pose of the camera, and the at least one additional pose of the camera corresponds to the panoramic orbital acquisition, a region of interest associated with the panoramic orbital acquisition.
Aspect 25: The method of Aspect 24, wherein determining the region of interest associated with the panoramic orbital acquisition comprises regressing a center point of the first pose of the camera, the second pose of the camera, and the at least one additional pose of the camera.
Aspect 26: The method of Aspect 23, further comprising determining, based on determining that the trajectory associated with the first pose of the camera, the second pose of the camera, and the at least one additional pose of the camera corresponds to the panoramic orbital acquisition, an orbital radius associated with the panoramic orbital acquisition.
Aspect 27: The method of Aspect 26, further comprising generating a 3D interactive rendering of the 3D representation of the scene, wherein generating the 3D interactive rendering comprises capturing images of the 3D representation of the scene with a virtual camera from a plurality of viewpoints along the orbital radius.
Aspect 28: The method of Aspect 17, wherein determining the capture type comprises determining a trajectory associated with the first pose of the camera, the second pose of the camera, and at least one additional pose of the camera corresponds to a panoramic acquisition.
Aspect 29: The method of Aspect 28, further comprising determining, based on determining that the trajectory associated with the first pose of the camera, the second pose of the camera, and the at least one additional pose of the camera corresponds to the panoramic acquisition, a center of projection associated with the panoramic acquisition.
Aspect 30: The method of Aspect 29, further comprising determining, based on determining that the trajectory associated with the first pose of the camera, the second pose of the camera, and the at least one additional pose of the camera corresponds to the panoramic orbital acquisition, a region of interest associated with the panoramic orbital acquisition.
Aspect 31: A non-transitory computer-readable storage medium having stored thereon instructions which, when executed by one or more processors, cause the one or more processors to perform any of the operations of aspects 1 to 30.
Aspect 32: An apparatus comprising one or more means for performing any of the operations of aspects 1 to 30.

What is claimed is:

1. An apparatus for processing one or more images, comprising:
at least one memory; and
at least one processor coupled to the at least one memory and configured to:
obtain a first image of a scene from a camera, wherein the first image of the scene is associated with a first pose of the camera;
obtain a second image of the scene from the camera, wherein the second image of the scene is associated with a second pose of the camera, the second pose being different from the first pose;
generate, based on the first image of the scene and the second image of the scene, a three-dimensional (3D) representation of the scene; and
generate, based on the 3D representation of the scene, a two-dimensional (2D) image of the 3D representation of the scene associated with a third pose, the third pose being different from the second pose of the camera and the first pose of the camera.

2. The apparatus of claim 1, wherein the at least one processor is further configured to:
determine, based on the first pose of the camera and the second pose of the camera, a capture type associated with the first pose of the camera and the second pose of the camera.

3. The apparatus of claim 2, wherein, to determine the capture type associated with the first pose of the camera and the second pose of the camera, the at least one processor is configured to determine whether a trajectory associated with the first pose of the camera, the second pose of the camera, and at least one additional pose of the camera corresponds to a linear trajectory.

4. The apparatus of claim 3, wherein the at least one processor is further configured to determine, based on determining that the trajectory associated with the first pose of the camera, the second pose of the camera, and the at least one additional pose of the camera corresponds to the linear trajectory, a plurality of rendering viewpoints for rendering the 3D representation of the scene.

5. The apparatus of claim 4, wherein the at least one processor is further configured to render a 2D panoramic image based on the 3D representation of the scene.

6. The apparatus of claim 4, wherein the at least one processor is further configured to generate a 3D interactive rendering of the 3D representation of the scene along a linear path.

7. The apparatus of claim 6, wherein, to determine the linear path, the at least one processor is configured to:
perform a linear regression of the first pose of the camera, the second pose of the camera, and the at least one additional pose of the camera; and
align the plurality of rendering viewpoints to a shared view direction.

8. The apparatus of claim 2, wherein, to determine the capture type associated with the first pose of the camera and the second pose of the camera, the at least one processor is configured to determine whether a trajectory associated with the first pose of the camera, the second pose of the camera, and at least one additional pose of the camera corresponds to an orbital acquisition.

9. The apparatus of claim 8, wherein the at least one processor is further configured to determine, based on determining that the trajectory associated with the first pose of the camera, the second pose of the camera, and the at least one additional pose of the camera corresponds to the orbital acquisition, a region of interest associated with the orbital acquisition.

10. The apparatus of claim 9, wherein, to determine the region of interest associated with the orbital acquisition, the at least one processor is configured to regress a center point of the first pose of the camera, the second pose of the camera, and the at least one additional pose of the camera.

11. The apparatus of claim 8, wherein the at least one processor is further configured to determine, based on determining that the trajectory associated with the first pose of the camera, the second pose of the camera, and the at least one additional pose of the camera corresponds to the orbital acquisition, an orbital radius associated with the orbital acquisition.

12. The apparatus of claim 11, wherein the at least one processor is further configured to generate a 3D interactive rendering of the 3D representation of the scene, wherein generating the 3D interactive rendering comprises capturing images of the 3D representation of the scene with a virtual camera from a plurality of viewpoints along the orbital radius.

13. The apparatus of claim 2, wherein, to determine the capture type associated with the first pose of the camera and the second pose of the camera, the at least one processor is configured to determine whether a trajectory associated with the first pose of the camera, the second pose of the camera, and at least one additional pose of the camera corresponds to a panoramic acquisition.

14. The apparatus of claim 13, wherein the at least one processor is further configured to determine, based on determining that the trajectory associated with the first pose of the camera, the second pose of the camera, and the at least one additional pose of the camera corresponds to the panoramic acquisition, a center of projection associated with the panoramic acquisition.

15. The apparatus of claim 14, wherein, to determine the center of projection associated with the panoramic acquisition, the at least one processor is configured to regress a center point of the first pose of the camera, the second pose of the camera, and the at least one additional pose of the camera.

16. A method for processing one or more images, the method comprising:
obtaining a first image of a scene from a camera, wherein the first image of the scene is associated with a first pose of the camera;
obtaining a second image of the scene from the camera, wherein the second image of the scene is associated with a second pose of the camera, the second pose being different from the first pose;
generating, based on the first image of the scene and the second image of the scene, a three-dimensional (3D) representation of the scene; and
generating, based on the 3D representation of the scene, a two-dimensional (2D) image of the 3D representation of the scene associated with a third pose, the third pose being different from the second pose of the camera and the first pose of the camera.

17. The method of claim 16, further comprising determining, based on the first pose of the camera and the second pose of the camera, a capture type associated with the first pose of the camera and the second pose of the camera.

18. The method of claim 17, wherein determining the capture type comprises determining whether a trajectory associated with the first pose of the camera, the second pose of the camera, and at least one additional pose of the camera corresponds to a linear trajectory.

19. The method of claim 17, wherein determining the capture type comprises determining whether a trajectory associated with the first pose of the camera, the second pose of the camera, and at least one additional pose of the camera corresponds to an orbital acquisition.

20. The method of claim 17, wherein determining the capture type comprises determining a trajectory associated with the first pose of the camera, the second pose of the camera, and at least one additional pose of the camera corresponds to a panoramic acquisition.
